(19) United States
(12) Patent Application Publication
(10) Pub. No.: US 2023/0117941 A1
(43) Pub. Date: Apr. 20, 2023

(54) System and Process For Tracking Liquidity Pool Tokens

(71) Applicant: Yield Monitor, Richmond, VA (US)

(72) Inventor: Christophe Dupont, Oudsbergen (BE)

(73) Assignee: Yield Monitor, Richmond, VA (US)

(21) Appl. No.: 17/966,427

(22) Filed: Oct. 14, 2022

Related U.S. Application Data
(60) Provisional application No. 63/255,613, filed on Oct. 14, 2021.

(51) Int. Cl. G06Q 40/06; H04L 9/32

(52) U.S. Cl. CPC G06Q 40/06; H04L 9/3213; H04L 2209/56

(57) ABSTRACT

A multi-chain and multi-DEX decentralized finance (DeFi) portfolio tracker uses a powerful relational database with an improved, continuous, self-updating process that constantly reflects value changes and associations with respect to individual symbols (tokens) across varying blockchain networks by integrating smart contracts from individual DeFi protocols. A web-based platform, backed by the system, provides crypto traders and investors with a “hub” where they can more efficiently track and visualize their LP Token and Yield Farm asset performance.

### CROSS REFERENCE TO RELATED APPLICATIONS

The present application claims the benefit of priority to U.S. Provisional Pat. Application No. 63/255,613, “SYSTEM AND METHOD FOR TRACKING LIQUIDITY POOL TOKENS” which was filed on Oct. 14, 2021 and which is incorporated herein by reference in its entirety.

### BACKGROUND OF THE EMBODIMENTS

### Field of the Embodiments

The embodiments herein are generally directed to an improved relational database and associate method for tracking smart contracts. In a specific example, the relational database and associated method are used to efficiently track digital currencies and, more particularly, cryptocurrencies and liquidity pool tokens.

### Description of the Related Art

The technology behind blockchains and cryptocurrency is quickly changing the payment and investing landscapes across the world.

Leveraging blockchain technology, consumers can see their transactions processed in as little as seconds to a couple of minutes; basically the time it takes for a transaction to be confirmed on-chain, regardless of holidays or the time of day or week. With blockchain, users have the opportunity to exchange funds more quickly and securely. With traditional equities trading, for example, the settlement and clearing process can take up to three days (or longer, if trading internationally), meaning that the money and shares are potentially being transferred or frozen for that period of time. Given the size of the sums involved, even the few days that the money is in transit can carry significant costs and risks for banks. Global consumers could potentially save billions in banking and insurance fees each year through blockchain-based applications.

Blockchain forms the bedrock technology for cryptocurrencies like Bitcoin. In contrast, the U.S. dollar is controlled by the Federal Reserve. Under traditional finance’s centralized authority system, a user’s personal data and accounts are technically at the whim of their bank or government. If a user’s bank is hacked, the client’s private information is at risk. If the client’s bank collapses or they live in a country with an unstable government, the value of —or access to — their currency may be at risk.

By spreading its operations across a network of computers, blockchain allows digital assets or tokenized assets, for example, cryptocurrencies, to operate without the need for a central authority. This not only reduces risk but also restructures and greatly reduces many of the processing and transaction fees. It can also give those in countries with volatile currencies or weak financial infrastructures a more stable currency with more applications and a wider network of individuals and institutions with whom they can transact or do business, both domestically and internationally.

Using cryptocurrency wallets for savings accounts or as a means of payment is especially profound for those who remain unbanked or have no state identification. Some countries may be war-torn or have governments that lack any real infrastructure to provide identification. Citizens of such countries may not have access to savings or brokerage accounts and, therefore, no way to safely store wealth or compile assets.

The success of Bitcoin has sparked a burgeoning new industry with new opportunities for revenue generation. As new blockchains and cryptocurrencies emerge, there is value to be gained through investment and trading. But there are also considerable barriers to entry and preventative costs due to the siloed nature of individual blockchains and the Decentralized Finance (DeFi) ecosystems within them. Accordingly, there is a need in the art for a system and process for providing inter-chain financial performance data accessibility in an efficient and scalable format.

### SUMMARY OF THE EMBODIMENTS

In a first exemplary embodiment, a system for monitoring and storing data linked to one or more smart contracts, the system comprises:a relational database; and at least one processing unit for initiating calls to one or more block chain nodes which store the one or more smart contracts, wherein each of the one or more smart contracts is defined by objects associated therewith and further wherein automatic operation of one or more objects of the one or more smart contracts results in the generation of one of new or changed data; the at least one processing unit being further configured to receive the new or changed data from the one or more block chain nodes and cause the new or changed data to be stored in the relational database in accordance with its associated smart contract.

In a second exemplary embodiment, a process for monitoring and storing data linked to one or more smart contracts, comprises: receiving at a processing unit associated with a relational database, a request for status of an object associated with a first smart contract; checking by the processing unit the relational database to determine if there is existing data related to the object or the associated first smart contract; determining by the processing unit there is no existing data related to the object and performing one or more searches to ascertain a location of the first smart contract, including locating a block chain network address for the first smart contract; initiating by the processing unit one or more calls to one or more nodes at the block chain network address for the first smart contract and requesting data conveying status of the object; receiving by the processing unit the data conveying status of the object and storing the data in the relational database in accordance with its associated first smart contract and a location thereof in the block chain network; and providing a response to the request for status.

### BRIEF DESCRIPTION OF THE FIGURES

The accompanying figures, which are included as part of the present specification, illustrate the presently preferred embodiments and together with the generally description given above and the detailed description of the preferred embodiments given below serve to explain and teach the principles described herein.

FIGS. 1A and 1B are schematics of a general call process flow (FIG. 1A) and a detailed call process flow (FIG. 1B) in accordance with embodiments herein;

FIG. 2 is an exemplary screenshot visualization of a universal dashboard report providing an exemplary individual graph of tracked Liquidity Pool performance in an identified network in accordance with an embodiment herein;

FIG. 3 is an exemplary screenshot showing an overview snapshot of a universal dashboard application home page, featuring all current tracked blockchains and the various DeFi products within those networks.in accordance with an embodiment herein;

FIGS. 4A, 4B, 4C, 4D provide a deeper look at Liquidity Pool Token price and performance data related to a specific pool pair, LINK.e - WAVAX, on the Trader Joe platform of the Avalanche (AVAX) network; and

FIGS. 5A, 5B, 5C, 5D provide a deeper look at Liquidity Pool Token price and performance data related to a specific pool pair, CAKE-WBNB, on the Pancake Swap platform of the Binance (BNB) network.

### DETAILED DESCRIPTION

### Definitions and Acronyms

ALGO: Algorand blockchain network.

AVAX: Avalanche blockchain platform.

Blockchain: a system of recording information in a way that makes it difficult or impossible to change, hack, or cheat the system. A blockchain is essentially a digital ledger of transactions that is duplicated and distributed across the entire network of computer systems (nodes) that support the blockchain. It differs from a typical database in the way it stores information; blockchains record and settle transactional data in blocks after a period of consensus. As new data comes in it is entered into and stored within fresh blocks. Once the block is filled with data it is chained onto the previous block and given an exact timestamp when added to the chain, which makes the data chained together in chronological order. Blockchain as referenced herein is used in a decentralized way so that no single person or group has control-rather, all infrastructure providers (nodes) or validators collectively retain control through majority. Decentralized blockchains are immutable, which means that the data entered is nearly irreversible. This means that transactions are permanently recorded and viewable to anyone. Blockchain is a type of distributed ledger technology (“DLT”).

Blockchain platform or Blockchain network: platform that supports a particular type of blockchain. Exemplary blockchains include Avalanche, BNB Chain, Ethereum, IBM Blockchain, Fantom, Hyperledger Fabric, Hyperledger Sawtooth, R3 Corda, etc.

BNB: BNB Chain (formerly Binance Smart Chain) blockchain network.

CEX: A centralized exchange is a cryptocurrency exchange that is operated by a company that owns it in a centralized manner, offering good liquidity and additional customer service features and control. Online trading platforms that match buyers and sellers of cryptocurrency. Examples include Coinbase, Binance, Kraken, etc.

Coin: A coin is a digital currency - often the native coin of a blockchain. It can be used as a source of value, a medium of exchange and/or for functional use on its blockchain.

Cryptocurrency: a digital currency in which transactions are verified and records maintained by a (varying degree of) decentralized system using cryptography, rather than by a centralized authority. Examples include Bitcoin (BTC), Litecoin (LTC), Ethereum (ETH), Cardano (ADA), Solana (SOL), USD Coin (USDC)C, Polkadot (DOT), etc.

Decentralized: Each computer or group of computers, i.e., nodes, that hold the blockchain is in a different geographic location and they are all operated by separate individuals or groups of nodes with combined computing power. Each node has a full record of the data that has been stored on the blockchain since its inception. If one node has an error in its data, it can use the thousands of other nodes as a reference point to correct itself. This way, no one node within the network can alter information held within it. Because of this, the history of transactions in each block that make up the blockchain is (nearly) irreversible.

DeFi: Decentralized finance is a system by which tokenized assets and financial products become available on a public decentralized blockchain network. That makes them open to anyone to use, rather than going through centralized middlemen like banks or brokerages. DeFi uses software written on blockchains to facilitate buyers, sellers, lenders, and borrowers interacting peer-to-peer (P2P) or with a software-based middleman (“Peer to Contract, P2C”) via a DEX, rather than a company or institution facilitating a transaction. DeFi uses technology to disintermediate centralized models and enable the provisioning of financial services anywhere for anyone regardless of ethnicity, age, or cultural identity.

DeFi ecosystem: the way toward building a collective of sheer monetary applications on top of a particular blockchain.

DeFi protocols: software protocols on blockchains that are standards and rules written to govern specific tasks or activities. They are interoperable, meaning they can be used by multiple entities at the same time to build a service or an app, enabling buyers, sellers, lenders, and borrowers to interact peer to peer. For an overview of DeFi, see “DeFI Beyond the Hype: The Emerging World of Decentralized Finance” May 2021, produced by the Wharton Blockchain and Digital Asset Project, in collaboration with the World Economic Forum, which is incorporated herein by reference.

DEX: A decentralized exchange that serves as a peer-to-peer (P2P) marketplace connecting cryptocurrency buyers and sellers. DEXs are non-custodial, meaning a user remains in control of their private keys and tokenized assets when transacting.

ETH: Ethereum blockchain platform

FTM: Fantom blockchain platform

Gas Fee: payments made by users to compensate for the computing energy required to process and validate transactions on the blockchain.

Impermanent loss: when user provides liquidity to a liquidity pool, and the price of user’s deposited assets changes compared to when user deposited them. The bigger this change is, the more the user is exposed to impermanent loss. In this case, the loss means less dollar value at the time of withdrawal than at the time of deposit. The loss is considered “impermanent” until the user exchanges the LP Token for the originally deposited assets.

Liquidity Pool: pools of tokens locked in smart contracts that provide liquidity in decentralized exchanges.

Liquidity Provider (LP): Liquidity provider is a user who funds a liquidity pool with crypto assets they own to facilitate trading on the platform and earn passive income on their deposit. Liquidity providers typically earn a share of the trading fees based on their stake in it.

LP token or pool token or liquidity token: represents a crypto liquidity provider’s share of liquidity pool. They are tokenized proof that the user provided assets to a pool. LP Tokens can be used in other DeFi products and services, like Yield Farming, depending on the user’s skill level and risk appetite.

Mainnet: an independent blockchain running its own network with its own independent technology and protocol. It is a live blockchain where its own, native cryptocurrencies or tokens are in use, as compared to a testnet or projects running on top of other popular networks such as Ethereum.

MATIC: Polygon blockchain network.

Non-Fungible Token (NFT): a unit of data, stored on a type of digital ledger called a blockchain, which can be sold and traded. Since each NFT may represent a different underlying asset and thus may have a different value, NFTs are non-fungible.

Smart contract: computer code / software that, in the context of Decentralized Finance (DeFi), can be used to interact with the blockchain to facilitate, verify, or negotiate a contract agreement between a user and a particular protocol, buyers and sellers, or lenders and borrowers. Smart contracts operate under a set of pre-determined conditions to which users agree. When those conditions are met, the terms of the agreement are automatically carried out. The smart contract coding language varies in accordance with each blockchain platform. So, by way of example, Ethereum smart contracts are coded using Ethereum’s own coding language, Solidity.

Token: or “crypto tokens”, is typically considered an asset built for a specific project on an existing blockchain. Typically, a token provides monetary or investment value, governance ability, and/or platform-specific features. So, by way of example, the Uniswap (UNI) token offers holders an investment asset, the ability to vote in the protocol’s governance proposals, etc.

Wallets (hot/cold): Wallets are digital asset ownership tools that allow a cryptocurrency owner to store, receive, and send cryptocurrencies and tokens. Unlike traditional currencies, there are no dedicated banks or physical wallets that can be used to keep cryptocurrency holdings secure. Hot and cold wallets offer varying degrees of access, functionality, and, subsequently, levels of access and security. Typically, users keep more active or traded assets in a hot wallet, and long-term investments in a cold wallet for increased safety.

Yield Farming: Typically, users deposit Liquidity Pool Tokens in different DeFi applications in order to maximize and diversify earnings. By moving tokens in and out of different protocols, profits can be strategically compounded based on a user’s ability and risk tolerance.

### Description of Embodiments

The process and system described herein is a multi-chain and multi-DEX decentralized finance (DeFi) portfolio tracker, at the core of which is powerful relational database with an improved, continuous, self-updating process that constantly reflects value changes and associations with respect to individual symbols (tokens) across varying blockchain networks by integrating smart contracts from individual DeFi protocols. A web-based platform, backed by the system, provides crypto traders and investors with a “hub” where they can more efficiently track and visualize their Liquidity Pool Token and Yield Farm asset performance.

This brings immediate value for users by streamlining how DeFi investors and traders can independently track portfolio performance and/or investment progress and make more data-driven investment decisions. The system described herein facilitates scalable on-chain asset data delivery.

As referenced in the Background, every blockchain creates their own ecosystem. From it, DeFi protocols are born and chain-specific ecosystems are created further still. Currently, most DeFi traders and investors must traverse these siloed networks by paying:
gas fees to send funds to and from cold/hot wallets and storage
additional gas fees to bridge funds across blockchains
fees to buy or sell assets / Liquidity Pool Tokens from DEXs
fees to stake or unstake Liquidity Pool Tokens in various protocols, yield farms, or automated compounding tools.
In addition to numerous fees, traversing these different blockchain ecosystems can be confusing or time-consuming. Users are presented with a myriad of potential missteps - any of which can result in the loss of partial/entire funds.

In an implementing embodiment described further below, a dashboard-style system of multi-chain, multi-DEX asset performance monitoring and DeFi investor portfolio tracking tools that leverage integrations with many major blockchains and their hundreds of DeFi protocols, liquidity pools, yield farms, and other products. At the heart of system is a scalable, multi-threaded database (hereafter “system database”) which maintains and monitors these integrations and, subsequently, price valuations. One skilled in the art will recognize that the system’s relational database, e.g., mySQL, may be hosted by any of a number of platforms, e.g., AWS.

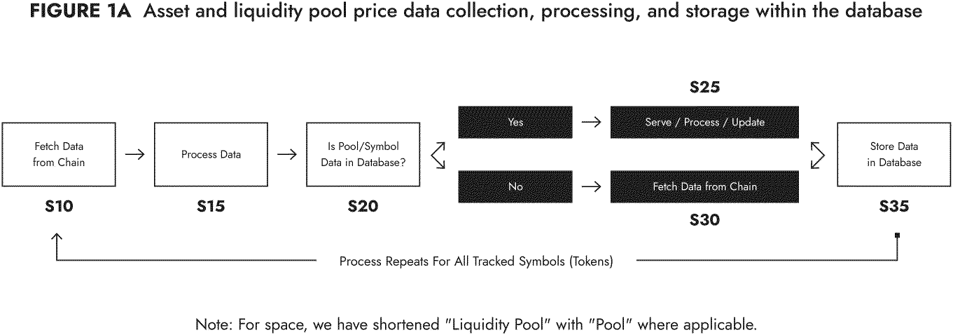

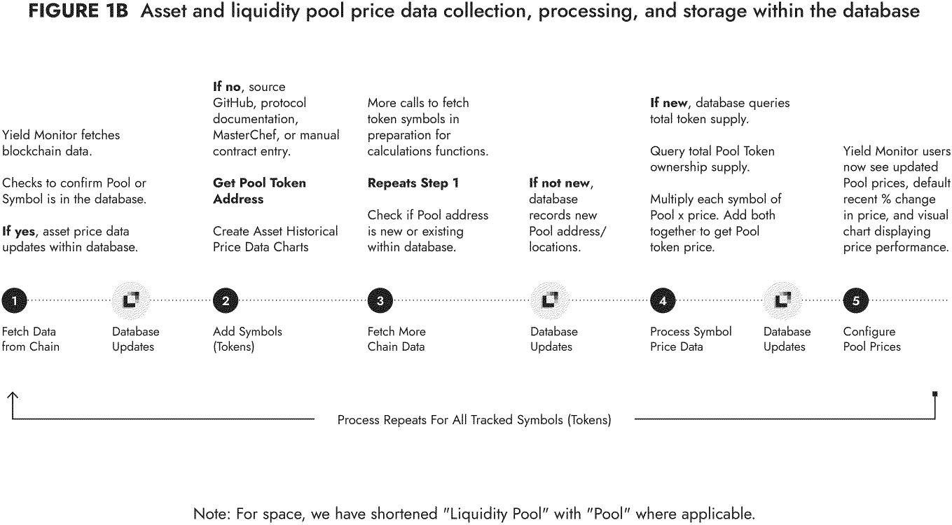

In accordance with the process schematic of FIG. 1, the system connects directly to Blockchain data (also referenced herein as “chain data”) via third-party and internal node infrastructure, and smart contracts (collectively “blockchain networks” or “networks”). These connections work to ensure that present and historical Liquidity Pool / token price and performance data are as accurate as possible. More particularly, the system performs the following general process steps for all tracked symbols (tokens): fetch data from chain S10; process fetched data S15, for each symbol (token) / Liquidity Pool check to confirm contract address is in system database S20; if yes, compare fetched data for each symbol (token) / Liquidity Pool to determine if any updates to previously stored data S25, update stored data for each symbol (token) / LP S30 and update and display asset price data accordingly; if no, i.e., no address exists for a symbol (token) / Liquidity Pool in system database, fetch data for the “new” symbol (token) / Liquidity Pool from the correct, i.e., associated, blockchain (network) S30; use result from the associated blockchain network to store new and/or missing data in the system database for the “new” symbol (token) / Liquidity Pool S35; calculate results (e.g., Liquidity Pool prices) and display in text and/or chart form for users. This general process is used for all calls. The process always checks the system database to determine if it needs to fetch the chain and update the database. This allows the application to drastically minimize the amount of calls the database need to do. Since calls are the element that’s heavily time intensive, this resource-saving process is critical as it allows the application to build the rest more efficiently at scale.

More specific workflows or subprocesses fall within the general process depending on the results of the general process calls. For example, the displayed charts include historical price data charts which are generated automatically by first determining which charts already exist and then determining the price for the existing charts. To determine existing charts, i.e., “Which charts are there?”, the system obtains the actual Liquidity Pool addresses (contract addresses) through, e.g., sourcing protocol documentation online, a MasterChef, a GitHub file, or manual entry. Once these Liquidity Pool contract addresses are entered in the system database, the system takes each address and executes the function from the general process: check if the system database has any Liquidity Pool row matching this address. If there is a matching row, simply save the farm and process ends. If no matching row, implement more calls to find the symbols (tokens) used, call these addresses to get the required decimals and symbol names. This allows for future Liquidity Pool / price calculations. The application now has a filled database with Liquidity Pool names and addresses (contracts) linked to symbols (tokens). This prevents the system from having to execute these duplicate calls every time the database needs data which would take time and resources and be limited by blockchain design and browser capability. Without the workflow process above, a system would get stuck repeating this step every time new data was requested.

Next, the price for the charts is calculated. Typically, a Liquidity Pool consists of two or more symbols (tokens). To determine the value of Liquidity Pool, the system queries the total supply of each symbol (token) in the Liquidity Pool. This tells the system how many tokens of each symbol a user owns of the user held one Liquidity Pool token. To get the price of the Liquidity Pool token, the system multiplies each symbol (token) by its respective price and adds results for all symbols (tokens) those together. The sum equals the Liquidity Pool token price.

To ensure an accurate price, the system queries the chain on a contract called a DEX. To query this contract, you necessarily pass a predetermined route. And the system can only use routes of actual Liquidity Pool pairs that exist. Take for example the route: symbol 1 → symbol 4 → symbol 6. If symbol 1 and symbol 6 have no Liquidity Pool, the system cannot use this route. There needs to be another symbol in between to link these. This action creates a useable route. So, in our example above, symbol 1 and symbol 6 have no Liquidity Pool, so we inserted symbol 4 to create a route. This would be because symbols 1 and 4 have an Liquidity Pool, and symbols 4 and 6 have an Liquidity Pool. The system prioritizes a direct Liquidity Pool or Liquidity Pool with a native chain token.

This prioritization is needed because there are limits to the volume and speed at which the data can be indexed. A limited node, for example, can only execute 5,000 calls every five (5) minutes to a network. Even if it, or a user, could do more, a web browser cannot handle this amount of requests. It would simply crash under the load. By way of example, PancakeSwap (on BNB Chain - formerly Binance Smart Chain) alone has 250,000 pairs and the system has to do three (3) calls to get a single set of LP pricing information. At a minimum, the system would have to make approximately 750,000 calls and that’s assuming the Liquidity Pool s consist of only two (2) symbols (tokens). With the workflow process described above, after initial population of the system database, the system is able to perform the pricing across all symbols (tokens). The system continuously queries all of the Liquidity Pool pairs of each DEX, as each pair has a number associated with it (so we can just check for new ones). And the system does this across multiple DEXs. The number grows as we integrate new blockchains and DEX protocols into the database. Since we only have to add the new DEXs, this is very fast.

Once the relational database is populated, the system reviews all the symbols (tokens) therein to check for all routes we can find from coin to $USD (or to any coin the user wants) and match these very efficiently. We will only save the routes that return a good value, i.e., most economical in USD value, to check these more frequently, e.g., approximately every 30 hours. Other routes are rechecked every few days or when the price moves more than 5% in either direction. We also do this periodically and keep the found routes saved. Old routes are discarded and replaced with newly found routes.

To retrieve the Liquidity Pool price for a particular Liquidity Pool pair, the system calls the router for each specific route which is saved in the system’s relational database together with the Liquidity Pool route. For example, we find route coin A → coin Z → coin B, and we are looking for coin A to coin B price chart. The system passes this route to the associated router which uses the route to calculate and report that the current price chart for coin A to coin B is, for example $1.1234567(...) USD.

Accordingly, the system embodied herein auto-updates and has all possible routes with minimized load times and electricity usage. The system is the cornerstone of a powerful portfolio tracking tool, wherein user’s including crypto traders and investors can more efficiently track and visualize their Liquidity Pool and yield farm asset performance.

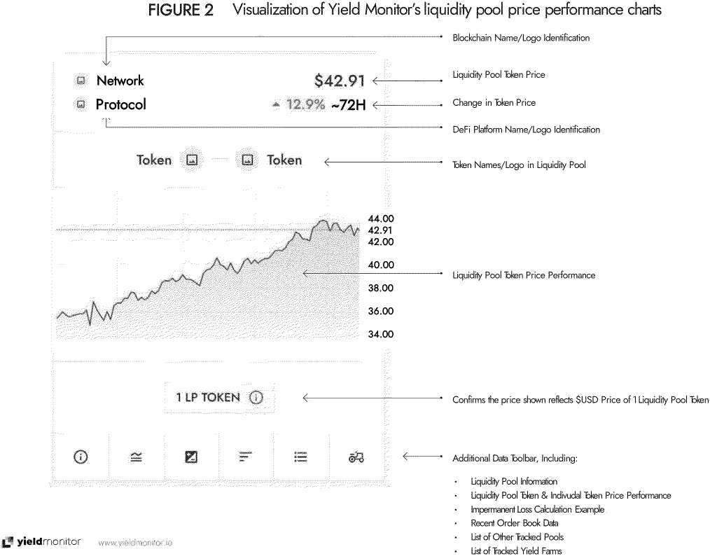

By way of example, the system’s calculations may be continuously updated and reported to users through a dashboard which generates real-time Liquidity Pool status pages, such as the one exemplified in FIG. 2. Through the dashboard, users are able to, among other features, visually track the performance of their Liquidity Pools across various blockchains 5 and DeFi protocols 10. For each Liquidity Pool Token 15, the dashboard provides current Liquidity Pool Token Price 20, change in token price 25, and a Liquidity Pool Token Price performance graph 30. Additional features of the dashboard include the ability for users to connect their wallet address to the system, and allow the system to review their existing Liquidity Pool tokens and provide price data and performance via an expanding user dashboard. One skilled in the art will recognize that with this information, the system could be expanded to provide a full portfolio view of all holdings, profit and loss, and trade history, as well as providing a full wallet display that shows users all holding, on all chains, in real time.

Additional features envisioned for the system through the dashboard include: the ability to facilitate trades using single-click buy/sell/swap buttons; access to industry-leading liquidity and advantageous prices based on their trade/need which helps users find the best trades / routes for each coin and Liquidity Pool; investing in a data-driven trading bot; access to review audit documentation for all featured Liquidity Pools.

The system contains the pre-or post-audited (TBD) Smart Contracts found within each DeFi ecosystem we integrate. Acting as a “universal dashboard” for DeFi protocols and their LPs, the system uses Smart Contracts that are assume to have already been approved and inspected. The system does not perform security or code audits to blockchains, software providers, or smart contracts. In a preferred embodiment, integrated DeFi protocols have been audited by third parties. These include (but are not limited to) Kudelski, ConsenSys, CertiK, Experfy, Hacken, Trail of Bits, OpenZeppelin, Quantstamp, and others known to those skilled in the art.

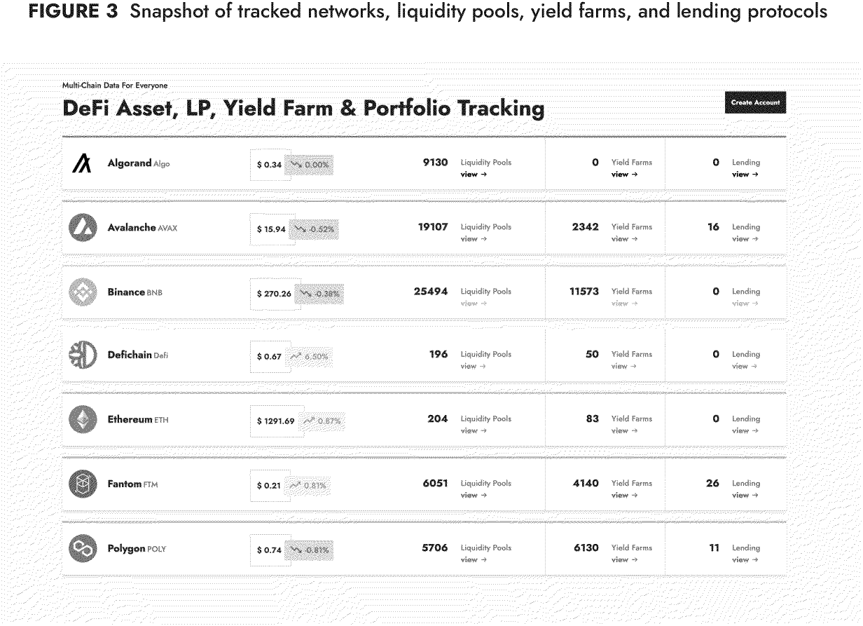

The system integrates with foundational blockchain networks and the DeFi tools built upon them. FIG. 3 shows an overview of the universal dashboard application home page, featuring all current tracked blockchains and the various DeFi products within those networks. In accordance with the description herein, the details provided on the home page are continually updated.

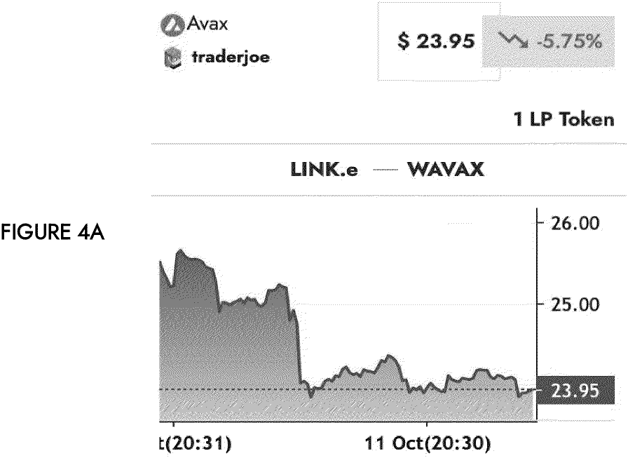

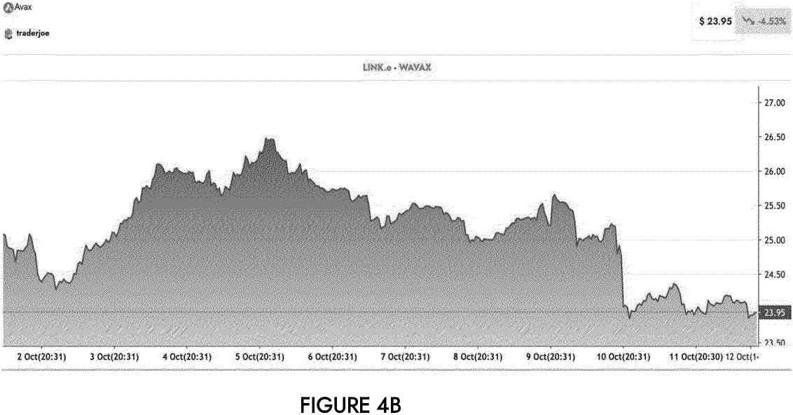

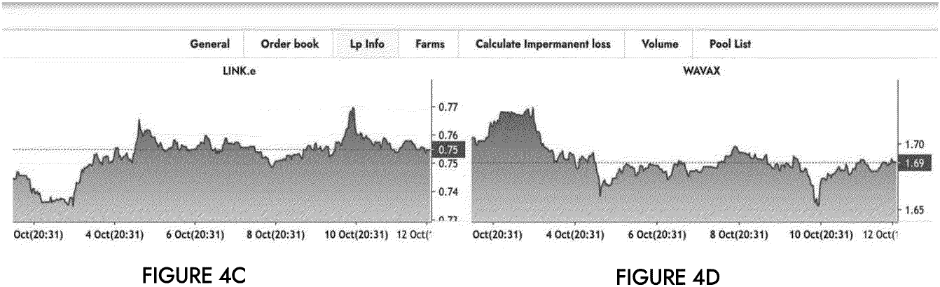

FIGS. 4A to 4D are individual graphs of a tracked Liquidity Pool on the Avalanche (AVAX) network from an exemplary screenshot of a universal dashboard report. More specifically, Liquidity Pools within the Traderjoe DeFi protocols for the LINK.e (FIG. 4C) and wAVAX (FIG. 4D) tokens and token pair LINK.e-wAVAX (FIGS. 4A, 4B) are shown. For example, FIG. 4A tracks, in real-time, value change (shown as -5.75%) of Link.e-WAVAX token pair over approximately 36 hours, while FIG. 4B shows value change (-4.53%) for the same token pair over approximately 9 days.

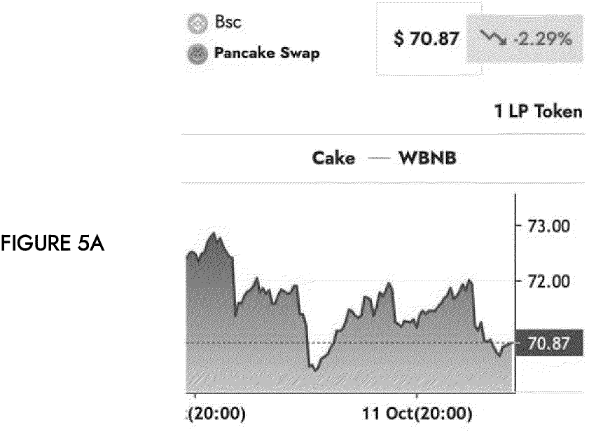

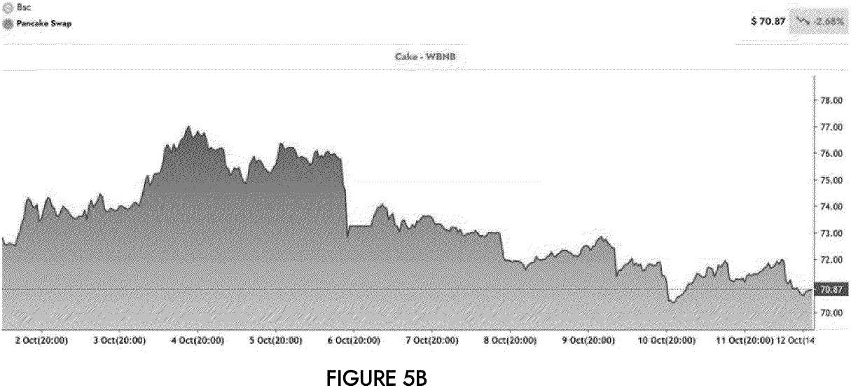

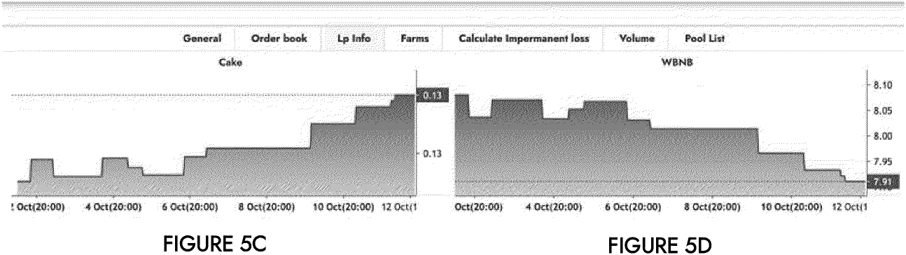

FIGS. 5A to 5D are individual graphs of a tracked Liquidity Pool on the BNB Chain (BNB) (formerly Binance Smart Chain, BSC) network from an exemplary screenshot of a universal dashboard report. More specifically, Liquidity Pools within the Pancake Swap DeFi protocol for the Cake (FIG. 5C) and WBNB (FIG. 5D) tokens and token pair Cake-WBNB (FIGS. 5A, 5B) are shown.. For example, FIG. 5A tracks, in real-time, value change (shown as -2.29%) of Cake-WBNB token pair over approximately 36 hours, while FIG. 5B shows value change (-2.68%) for the same token pair over approximately 9 days.

The relational database and associated method for data fetching, tracking, storage, sorting, filtering and updating described above is not limited to application to the multi-chain, multi-DEX asset performance monitoring example described above. One skilled in the art will appreciate that the core relational database and general process of FIG. 1 may be implemented to fetch, track, store, sort, filter any smart contracts and the objects thereof, i.e., signatories, the subject of agreement or contract; and the specific terms. By way of example, instead of smart contracts governing Liquidity Pools and tracked symbols (tokens) which are fungible, the general process of FIG. 1 may be used to track, store, sort and update data related to smart contracts governing non-fungible tokens (NFTs). Smart contracts are transforming numerous industries including healthcare, supply chain, smart grids, government (voting systems), financial industries, just to name a few. The ability of the presently described relational database and associated method to efficiently provide users with access to smart contract status on an on-going basis meets a critical need in a fast-growing industry.

One skilled in the art will appreciate that myriad of different processing unit configurations, e.g., desktop processors, servers, which may be used to implement calls to/from/between the relational database, chain nodes and other resources referenced herein.

1. A system for monitoring and storing data linked to one or more smart contracts, the system comprising:
a relational database; and
at least one processing unit for initiating calls to one or more block chain nodes which store the one or more smart contracts, wherein each of the one or more smart contracts is defined by objects associated therewith and further wherein automatic operation of one or more objects of the one or more smart contracts results in the generation of one of new or changed data;
the at least one processing unit being further configured to receive the new or changed data from the one or more block chain nodes and cause the new or changed data to be stored in the relational database in accordance with its associated smart contract.

2. The system of claim 1, wherein the relational database stores the new or changed data in accordance with one or more objects of its associate smart contract.

3. The system of claim 2, wherein the one or more objects includes terms of the smart contract, subject of the smart contract and signatories to the smart contract.

4. The system of claim 1, wherein the new or changed data received by the processing unit triggers a request to fetch additional data from one or more block chain nodes.

5. The system of claim 1, wherein the relational database stores data linked to multiple smart contracts and further wherein the automatic operation of one or more objects of a first of the multiple smart contracts results in first new or changed data which changes a value of a subject of at least a second of the multiple smart contracts; and
the at least one processing unit tracks both the first new or changed data and the changed value of a subject of the at least a second of the multiple smart contracts and stores both in the relational database.

6. The system of claim 5, wherein the first new or changed data is a change in value of a subject of the first of the multiple smart contracts and the relational database stores this change in value of the subject of the first of the multiple smart contracts; and
further wherein, the first of the multiple smart contracts is stored on a first block chain network and the second of the multiple smart contracts is stored on a second block chain network and the relational database stores route information for accessing a location on the first block chain for the change in value of the subject of the first of the multiple smart contracts and stores route information for the change in value of the subject of the second of the multiple smart contracts and further links the routes.

7. A process for monitoring and storing data linked to one or more smart contracts, the system comprising:
receiving at a processing unit associated with a relational database, a request for status of an object associated with a first smart contract;
checking by the processing unit the relational database to determine if there is existing data related to the object or the associated first smart contract;
determining by the processing unit there is no existing data related to the object and performing one or more searches to ascertain a location of the first smart contract, including locating a block chain network address for the first smart contract;
initiating by the processing unit one or more calls to one or more nodes at the block chain network address for the first smart contract and requesting data conveying status of the object;
receiving by the processing unit the data conveying status of the object and storing the data in the relational database in accordance with its associated first smart contract and a location thereof in the block chain network; and
providing a response to the request for status.

8. The process according to claim 7, further comprising:
receiving by the processing unit a second request for status of an object associated with a second smart contract, wherein the status of the object associated with the second smart contract is linked to the status of the object associated with the first smart contract, and further wherein the second smart contract is on a second block chain network;
initiating a call by the processing unit to the first block chain network to determine if there is a change in status of the object associated with the first smart contract network;
determining by the processing unit that there has been a change in status of the object associated with the first smart contract network and storing data indicative of this change in status in the relational database;
determining a change in the status of the object associated with the second smart contract based on the change in the status of the object associated with the first smart contract and storing data indicative of this change in status in the relational database in accordance with its associated second smart contract and a location thereof in the second block chain network; and
providing a response to the request for status.

9. The process of claim 7, wherein an object is selected from the group consisting of terms of the smart contract, subject of the smart contract and signatories to the smart contract.

10. The process of claim 7, wherein 9, wherein the object is a token and the change in status is change in value of the token.
